(19) United States
(12) Patent Application Publication
(10) Pub. No.: US 2015/0348550 A1
(43) Pub. Date: Dec. 3, 2015

(54) Speech-to-text input method and system combining gaze tracking technology

(71) Applicant: CONTINENTAL AUTOMOTIVE GMBH, Hannover (DE)

(72) Inventor: Bo ZHANG, Shanghai (CN)

(21) Appl. No.: 14/655,016

(22) PCT Filed: Dec. 18, 2013
(86) PCT No.: PCT/EP2013/077193

§ 371 Date: Jun. 23, 2015

(30) Foreign Application Priority Data
Dec. 24, 2012 (CN) 201210566840.5

(51) Int. Cl. G10L 15/26; G06F 17/24; G10L 15/25; G06F 3/16; G06F 3/01

(52) U.S. Cl. CPC G10L 15/26; G06F 3/167; G06F 3/013; G10L 15/25; G06F 17/24

(57) ABSTRACT

A speech-to-text input method includes: receiving a speech input from a user; converting the speech input into text through speech recognition; displaying the recognized text to the user; determining a gaze position of the user on a display by tracking the eye movement of the user; displaying an edit cursor at the gaze position when the gaze position is located at the displayed text; receiving a speech edit command from the user; recognizing the speech edit command through speech recognition; and editing the text at the edit cursor according to the recognized speech edit command.

### CROSS-REFERENCE TO RELATED APPLICATIONS

This is a U.S. national stage of application No. PCT/EP2013/077193, filed on 18 Dec. 2013, which claims priority to the Chinese Application No. CN 201210566840.5 filed 24 Dec. 2012, the content of both incorporated herein by reference.

### BACKGROUND OF THE INVENTION

1. Field of the Invention

The present invention relates to the field of speech-to-text input, and particularly, to a speech-to-text input method and system combining a gaze tracking technology.

2. Related Art

Speech-to-text input of non-specific information can be performed through a cloud speech recognition technology. The technology is generally envisaged to be applied to input text on special occasions, for example, inputting a short message or a navigation destination name while one is driving.

Due to the limits of the current cloud speech recognition technology and the complex requirements of natural speech for the context, the recognition correctness rate is generally very low when performing speech-to-text input of non-specific information. A user needs to locate and recognize an error point through traditional interactive devices such as a mouse, keyboard, turning wheel, touch screen, and edit and modify same. When modifying the text, the user needs to perform locating by gazing at the screen and operating the interactive devices at the same time, and to perform an editing operation (such as replace, delete, etc.). To a great extent, this distracts the attention of the user. For special occasions, such as driving, this operation may result in a great risk.

### SUMMARY OF THE INVENTION

In order to solve the abovementioned disadvantages of the existing speech-to-text input methods, the technical solution of the present invention is proposed.

In one aspect of the present invention, a speech-to-text input method is provided, including: receiving a speech input from a user; converting the speech input into text through speech recognition; displaying the recognized text to the user; determining a gaze position of the user on a display by tracking the eye movement of the user; displaying an edit cursor at the gaze position when said gaze position is located at the displayed text; receiving a speech edit command from the user; recognizing the speech edit command through speech recognition; and editing the text at the edit cursor according to the recognized speech edit command.

In another aspect of the present invention, a speech-to-text input system is provided, including: a receiving module configured to receive a speech input from a user; a speech recognition module configured to convert the speech input into text through speech recognition; a display module configured to display the recognized text to the user; a gaze tracking module configured to determine a gaze position of the user on the displayed text by tracking the eye movement of the user; the display module further configured to display an edit cursor at the gaze position when the gaze position is located at the displayed text; the receiving module further configured to receive a speech edit command from the user; the speech recognition module further configured to recognize the speech edit command through speech recognition; and an edit module configured to edit the text at the edit cursor according to the recognized speech edit command.

The technical solution of the present invention realizes that what one sees is what one selects, without the cooperation of hands and eyes, and the user need not operate a specific input device for locating, so that it makes it easier for the user to modify the speech recognition text and improves the convenience and security of inputting and editing the text in situations of driving, etc.

### BRIEF DESCRIPTION OF THE DRAWINGS

FIG. 1 shows a functional block diagram of a speech-to-text input system according to an embodiment of the present invention;

FIG. 2 schematically shows a speech-to-text input system according to a further embodiment of the present invention;

FIG. 3 shows a speech-to-text input method according to an embodiment of the present invention; and

FIGS. 4A-4D show an example application scenario of a speech-to-text input system and method according to an embodiment of the present invention.

### DETAILED DESCRIPTION OF THE PRESENTLY PREFERRED EMBODIMENTS

The present invention combines a gaze tracking technology and speech recognition, and uses the gaze tracking technology to locate the position required to be modified in the text of speech recognition, thus facilitating the modification of the text of speech recognition.

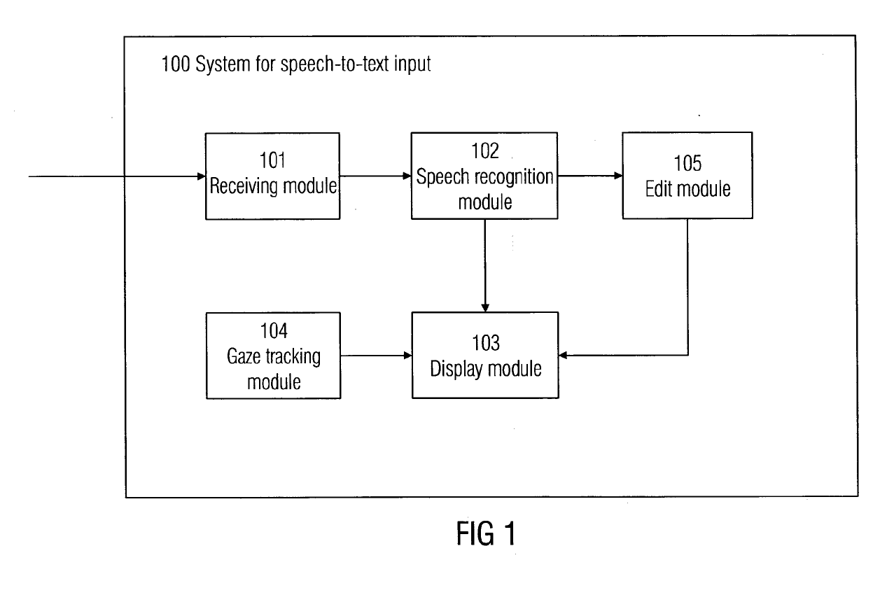

Embodiments of the present invention will now be described in detail by reference to the accompanying drawings. FIG. 1 shows a functional block diagram of a speech-to-text input system 100 according to an embodiment of the present invention. As shown in FIG. 1, the speech-to-text input system 100 comprises: a receiving module 101 configured to receive a speech input from a user; a speech recognition module 102 configured to convert the speech input into text through speech recognition; a display module 103 configured to display the recognized text; a gaze tracking module 104 configured to determine a gaze position of the user on the displayed text by way of tracking the eye movement of the user, the display module 103 being further configured to display an edit cursor at the gaze position when the gaze position is located at the displayed text. The receiving module 101 is further configured to receive a speech edit command from the user. The speech recognition module 102 is further configured to recognize the speech edit command through speech recognition. An edit module 105 is configured to edit the text at the edit cursor according to the recognized speech edit command.

According to the embodiments of the present invention, the editing of the edit module 105 according to the recognized speech edit command includes any one or more of the following: selecting a word before/a word after the edit cursor position; replacing the word before/the word after the edit cursor position with a character, word, phrase or sentence of the speech input of the user; deleting the word before/the word after the edit cursor position; selecting a character before/a character after the edit cursor position; replacing the character before/the character after the edit cursor position with a character, word, phrase or sentence of the speech input of the user; deleting a character before/a character after the edit cursor position; deleting all the contents after the edit cursor position; deleting all the contents before the edit cursor position; inserting the character, word, phrase or sentence of the speech input of the user at the edit cursor position; selecting the word located at the edit cursor position; replacing the selected word or character with the character, word, phrase or sentence of the speech input of the user; and deleting the selected word or character.

According to the embodiments of the present invention, the system 100 is implemented in a vehicle, the display module 103 has a display screen implemented by a front windshield of the vehicle, and the display module applies a head-up display technology.

According to the embodiments of the present invention, the speech recognition module 102 has a remote speech recognition system that communicates with the receiving module and the edit module in a wireless manner.

According to the embodiments of the present invention, the gaze tracking module 104 comprises an eye tracker configured to track and measure a rotation angle of the eyeballs, and a gaze position determination device configured to estimate and determine the gaze position of the eyes according to the rotation angle of the eyeballs measured by the eye tracker.

According to the embodiments of the present invention, the receiving module 101 has a microphone configured to receive the speech input from the user.

According to the embodiments of the present invention, the system further comprises a controller (not shown) configured to at least control the operation of the receiving module, speech recognition module, display module and gaze tracking module, wherein the controller is implemented by a computing device which comprises a processor and a storage.

As can be understood by those skilled in the art, in some embodiments of the present invention, various modules in the speech-to-text input system 100 can correspond to various corresponding software function modules, wherein the various software function modules can be stored in a volatile or non-volatile storage of the computing device, and can be read and executed by the processor of the computing device so as to execute the various corresponding functions. The computing device, for example, is the controller. Certainly, at least some of various modules in the speech-to-text input system 100 can also comprise dedicated hardware. As can further be understood by those skilled in the art, in some embodiments of the present invention, at least some of various modules in the speech-to-text input system 100 can comprise an interface, communication and control function for a corresponding external device (the interface, communication and control function can be implemented by software, hardware or a combination thereof) so as to execute a designated function of the module through the corresponding external device. For example, the receiving module 101 can have a microphone, and can have an interface circuit of the microphone, and can further have a microphone driver and a logic which performs de-noising processing on a speech signal received from the microphone (the logic can be implemented by a dedicated hardware circuit and also can be implemented by a software program) so as to receive a speech input from a user and receive a speech edit command from the user. The speech recognition module 102 can have a speech recognition system, and can comprise a communication interface to the speech recognition system so as to convert the speech input into text. The display module 103 can have a display, and can further have an interface circuit and a display driver so as to display the recognized text and display an edit cursor at the gaze position when the gaze position is located at the displayed text. The gaze tracking module 104 can have the eye tracker and a gaze position determination device, and can have an interface circuit and an eye tracker driver of the eye tracker so as to determine a gaze position of the user on the displayed text by way of tracking the eye movement of the user.

The above describes the speech-to-text input system according to some embodiments of the present invention by reference to the accompanying drawings. It should be pointed out that the above description is merely an illustrative description of the present invention, and does not limit the present invention. In other embodiments of the present invention, the speech-to-text input system can have more, less or different modules, wherein some modules can be divided into smaller modules or be merged into larger modules, and the relationship of connection, containing, function, etc., between various modules can be different from those described. For example, generally speaking, at least some of the functions executed by the receiving module, speech recognition module, display module 103 and gaze tracking module 104 and edit module 105 can be also executed by a controller.

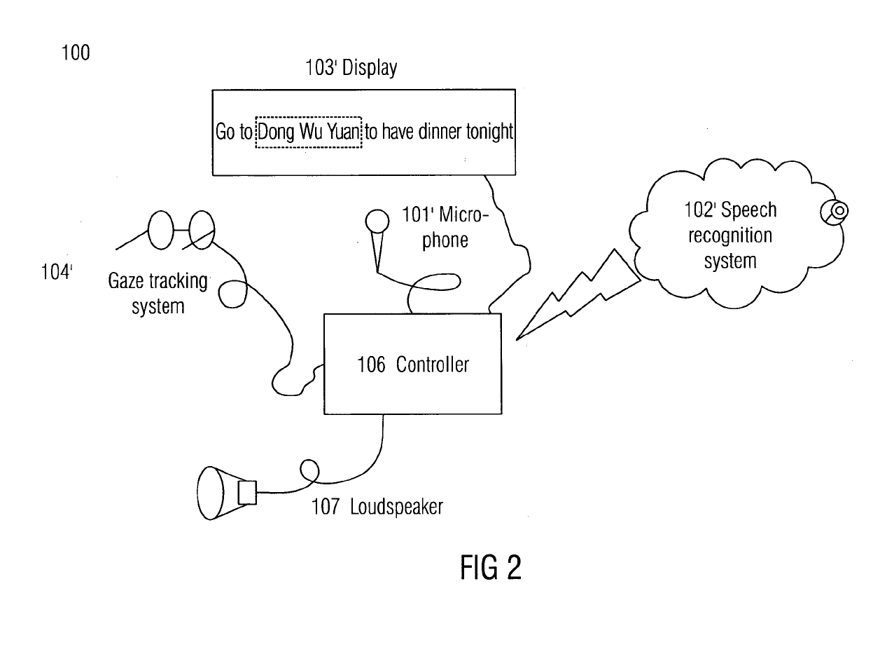

FIG. 2 schematically shows a speech-to-text input system 100 according to a further embodiment of the present invention. As shown in FIG. 2, the speech-to-text input system 100 comprises: a microphone 101′ configured to receive a speech input of a user and convert same into a speech signal; a controller 106 configured to receive the speech signal from the microphone 101′, transmit same to a speech recognition system 102′, receive text from the speech recognition system 102′ obtained by performing speech recognition on the speech signal, and send the text to a display 103′ for displaying; the display 103′ configured to display the text; a gaze tracking system 104′ configured to determine a gaze position of the user on the display 103′ by way of tracking the eye movement of the user; said controller 106 is further configured to receive the gaze position of the user on the display 103′ from the gaze tracking system 104′, and display an edit cursor at said gaze position through the display 103′ when said gaze position is located at the displayed text. The controller 106 is further configured to receive a speech edit command of the user from the microphone 101′, transmit same to the speech recognition system 102′, receive the recognized speech edit command from the speech recognition system 102′, and edit the displayed text according to the recognized speech edit command. At this moment, the controller 106 comprises all the functions of the edit module 105.

The microphone 101′ can be any known or future developed microphone that can receive a speech input of a user and convert same into a speech signal.

The controller 106 can be any device that can execute each abovementioned function. In some embodiments, the controller 106 can be implemented by a computing device, which computing device can have a processing unit and a storage unit, wherein the storage unit can store programs used for executing various n abovementioned functions, and the processing unit can execute various abovementioned functions through reading and executing the programs stored in the storage unit.

The display 103′ can be any existing or future developed display that can at least display text. In an embodiment of the present invention, the system 100 is implemented in a vehicle; furthermore, the display 103′ can have a display screen implemented by a front windshield of the vehicle. As is known to those skilled in the art, the front windshield of the vehicle can be made to be a display screen by embedding an LED display membrane, etc., in the front windshield of the vehicle. Furthermore, the display 103′ can apply a head-up display technology. As is known to those skilled in the art, the head-up display technology means that an image displayed on the front windshield of a vehicle seems to be located right ahead of the vehicle from the view of the driver through processing the image. Thus, the driver can gaze at the scene in front of the vehicle and gaze at the text displayed on the front windshield at the same time while driving the vehicle, but need not change the gaze direction or adjust the focal length of his/her eyes so as to further improve driving safety when editing the text. Certainly, the display 103′ can also be a separate display in the vehicle (such as a display on the dashboard). Alternatively, the display 103′ can also be a display that has the display screen implemented by the front windshield but does not apply the head-up display technology, and in such a display, the image displayed on the front windshield of the vehicle does not suffer from the abovementioned special processing, but is displayed normally.

The gaze tracking system 104′ can be any existing or future developed gaze tracking system that can determine the gaze position of the user on the display. As is known to those skilled in the art, the gaze tracking system generally comprises an eye tracker, which can track and measure the rotation angle of the eyeballs, and a gaze position determination device which determines the gaze position of the eyes according to the rotation angle of the eyeballs measured by the eye tracker. There are various types of available gaze tracking systems which use different technologies at present. For example, one type of gaze tracking system comprises a special contact lens that has an embedded mirror or magnetic field sensor, wherein the contact lens will rotate along with the rotation of eyeballs such that the embedded mirror or magnetic field sensor can track and measure the rotation angle of the eyeballs, and comprises a gaze position determination device that determines the gaze position of the eyes according to the relevant information about the rotation angle of the eyeballs and the position of the eyes or the head, etc. Another type of gaze tracking system uses a contactless optical method to measure the rotation of the eyeballs, wherein a typical method is that infrared light rays are reflected from the eyes, and received by a camera or other specially designed optical sensors, and the received eye image is analyzed so as to obtain the rotation angle of the eyes, and then the gaze position of the user is determined according to the relevant information about the rotation angle of the eyes and the position of the eyes or the head, etc. Further another type of gaze tracking system uses an electric potential measured by an electrode located around the eyes to measure the rotation angle of the eyeballs, and determine the gaze position of the user according to the relevant information about the rotation angle of the eyeballs and the position of the eyes or the head, etc. In order to acquire the position of the eyes or the head, some gaze tracking systems further comprise a head locator so as to accurately compute the gaze position of the eyes while allowing the head to move freely. The head locator can be implemented by a video camera (such as a video camera placed at two sides of the dashboard of the vehicle) placed in front of the user and a relevant computing module. According to some embodiments of the present invention, at least a part of the gaze tracking system 104′, such as the gaze position determination device therein, is included in the controller 106.

According to some embodiments of the present invention, the gaze tracking system 104′ continuously tracks the eye movement of the user and determines the gaze position of the user on the display 103′, and when the controller 106 judges that the gaze position of the user on the display 103′ is located at the displayed text, the edit cursor is displayed continuously at the gaze position through the display 103′. When the gaze position of the user changes, the displayed position of the edit cursor will also change accordingly. Thus, when the displayed position of the edit cursor is not the edit position required by the user, the user can change the displayed position of the edit cursor through changing gaze position. Moreover, once the displayed position of the edit cursor is the edit position required by the user, the user needs to give a speech edit command in time.

Besides the abovementioned speech edit command, in other embodiments of the present invention, the speech edit command can include more, less or different commands. For example, it also can be taken into account that the speech edit command comprises commands for moving the position of the edit cursor, such as “forward”, “backward”, etc. Accordingly, when a certain recognized speech edit command is received, the controller 106 will execute a corresponding editing operation. For example, as regards each recognized command which is received: selecting a former word/a latter word, replacing the former word/the latter word with XX (“XX” represents any character, word, phrase or sentence which is spoken out by the user according to actual requirements), deleting the former word/the latter word, selecting a former character/a latter character, replacing the former character/the latter character with XX, deleting the former character/the latter character, deleting all the latter contents, deleting all the former contents, inserting XX, selecting the word, replacing with XX, deleting etc., the controller 106 will execute the following operations respectively: selecting a word before/a word after the edit cursor position, replacing the word before/the word after the edit cursor position with XX, deleting the word before/the word after the edit cursor position, selecting a character before/a character after the edit cursor position, replacing the character before/the character after the edit cursor position with XX, deleting the character before/the character after the edit cursor position, deleting all the contents after the edit cursor position, deleting all the contents before the edit cursor position, inserting XX at the edit cursor position, selecting the word at which the edit cursor position is located, replacing the selected word or character with XX, deleting the selected word or character, etc. As can be understood by those skilled in the art, when the controller 106 executes the operations of selecting, deleting or replacing the character or the word, etc., the character or the word to be selected, deleted or replaced is required to be determined first, and this can be implemented with the help of one or more of various known technical means of looking up a dictionary, applying a grammatical rule, etc.

The speech recognition system 102′ can be any appropriate speech recognition system. In some embodiments of the present invention, the speech recognition system 102′ is a remote speech recognition system. Furthermore, the controller 106 communicates with a remote recognition service in a wireless communication manner (for example, such as any type of various existing wireless communication manners of GPRS, CDMA, WiFi, etc. or a future developed wireless communication manner), so as to transmit a speech signal or a speech edit command to be recognized to the remote recognition service for performing speech recognition, and receive a corresponding text or an edit command which acts as speech recognition result from the remote recognition service. Such a wireless communication manner is particularly suitable to the embodiment of implementing the system 100 in the vehicle therein. Certainly, in some other embodiments of the present invention, the controller 106 can also communicate with a remote speech recognition service in a wired communication manner; or the controller 106 can also communicate with other speech recognition services besides the remote speech recognition service so as to perform speech recognition; or the controller 106 can also use a local speech recognition system or module to perform speech recognition. The speech recognition system 102′ can be both understood as being located outside the speech-to-text input system 100 and understood as being included inside the speech-to-text input system 100.

In some embodiments of the present invention, the speech-to-text input system 100 can further have an optional loudspeaker 107 configured to output the text recognized by the speech recognition system 102′ in a manner of speech (i.e., the text displayed on the display 103′). Furthermore, the loudspeaker 107 can be further configured to output the speech edit command recognized by the speech recognition system 102′ and other prompt information. Thus, the user can learn the text or the edit command recognized by the speech recognition system 102′ without the need for viewing the display, judge whether the recognized text or edit command is correct, and initiate an edit operation through gazing at an error in the displayed text on the display only when judging that the recognized text is incorrect; or give a speech edit command again when judging that the recognized edit command is wrong. This is especially suitable for occasions of vehicle driving, etc.

In some other embodiments of the present invention, the speech-to-text input system 100 can further comprise other optional devices which are not shown, for example, traditional user input devices such as a mouse, keyboard, etc. Moreover, the display 103′ can be a touch screen so as to be used as an input device and a display device at the same time.

The speech-to-text input system 100 can be applied to various occasions, such as short message input, navigation destination input, etc. When the speech-to-text input system 100 is applied to the short message input, the speech-to-text input system 100 can be integrated with a short message transmitting system (for example, any short message transmitting system such as a short message transmitting system on the vehicle, etc.) so as to create and edit a short message to be sent for the short message transmitting system. When the speech-to-text input system 100 is applied to a navigation destination input, the speech-to-text input system 100 can be integrated with a navigation system (for example, any navigation system such as a navigation system on the vehicle, etc.) so as to provide a destination name, etc., for the navigation system. Moreover, in this case, the speech-to-text input system 100 can share the display 103′, the microphone 101′, the loudspeaker 107, the computing device used for implementing the controller 106, etc., with the navigation system. The speech-to-text input system 100 can further be applied to other fields such as medical equipment, etc. For example, the speech-to-text input system 100 can be installed in a sickroom, a patient with limb paralysis can thus express himself/herself in the manner of speech plus gaze edit, and send same to medical care personnel.

The above describes a speech-to-text input system according to some embodiments of the present invention by reference to the accompanying drawings. It should be pointed out that the above description is merely an illustrative description for the present invention, and does not limit the present invention. In other embodiments of the present invention, the speech-to-text input system can have more, less or different modules, wherein some modules can be divided into smaller modules or be merged into larger modules, and the relationship of connection, containing, function, etc., between various modules can be different from those described.

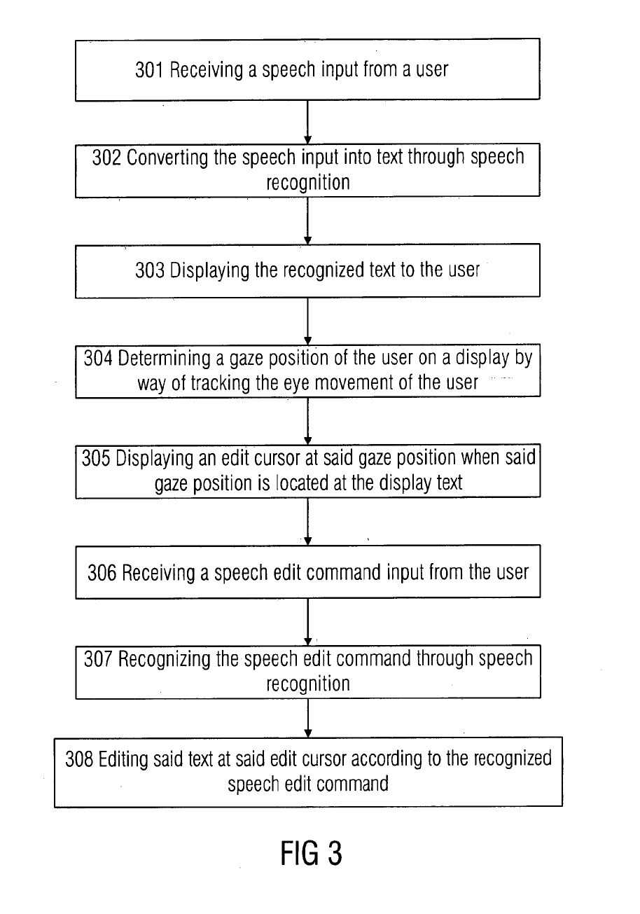

FIG. 3 shows a speech-to-text input method according to an embodiment of the present invention. The speech-to-text input method can be implemented by the above-mentioned speech-to-text input system 100, and can also be implemented by other systems or devices. As shown in FIG. 3, the method includes:

in step 301, receiving a speech input from a user;
in step 302, converting the speech input into text through speech recognition;
in step 303, displaying the recognized text to the user; in step 304, determining a gaze position of the user on a display by tracking the eye movement of the user; in step 305, displaying an edit cursor at the gaze position when the gaze position is located at the displayed text; in step 306, receiving a speech edit command input from the user;
in step 307, recognizing the speech edit command through speech recognition; and
in step 308, editing the text at the edit cursor according to the recognized speech edit command.

According to the embodiments of the present invention, the editing according to the speech edit command includes any one or more of the following: selecting a word before/a word after the edit cursor position; replacing the word before/the word after the edit cursor position with a character, word, phrase or sentence of the speech input of the user; deleting the word before/the word after the edit cursor position; selecting a character before/a character after the edit cursor position; replacing the character before/the character after the edit cursor position with the character, word, phrase or sentence of the speech input of the user; deleting the character before/the character after the edit cursor position; deleting all the contents after the edit cursor position; deleting all the contents before the edit cursor position; inserting the character, word, phrase or sentence of the speech input of the user at the edit cursor position; selecting the word located at the edit cursor position; replacing the selected word or character with the character, word, phrase or sentence of the speech input of the user; and deleting the selected word or character.

According to the embodiments of the present invention, the method is implemented in a vehicle, the display comprises a display screen implemented by a front windshield of the vehicle, and the display applies a head-up display technology.

According to the embodiments of the present invention, the speech recognition is executed by a remote speech recognition system that communicates with the local system in a wireless manner.

The above describes in detail the speech-to-text input method according to the embodiments of the present invention by reference to the accompanying drawings. It should be pointed out that the above description is merely an illustrative description for the present invention, and does not limit the present invention. In other embodiments of the present invention, the speech-to-text input method can have more, less or different steps, wherein some steps can be divided into smaller steps or be merged into larger steps, and the relationship of sequence, containing, function, etc., between each step can be different from those described.

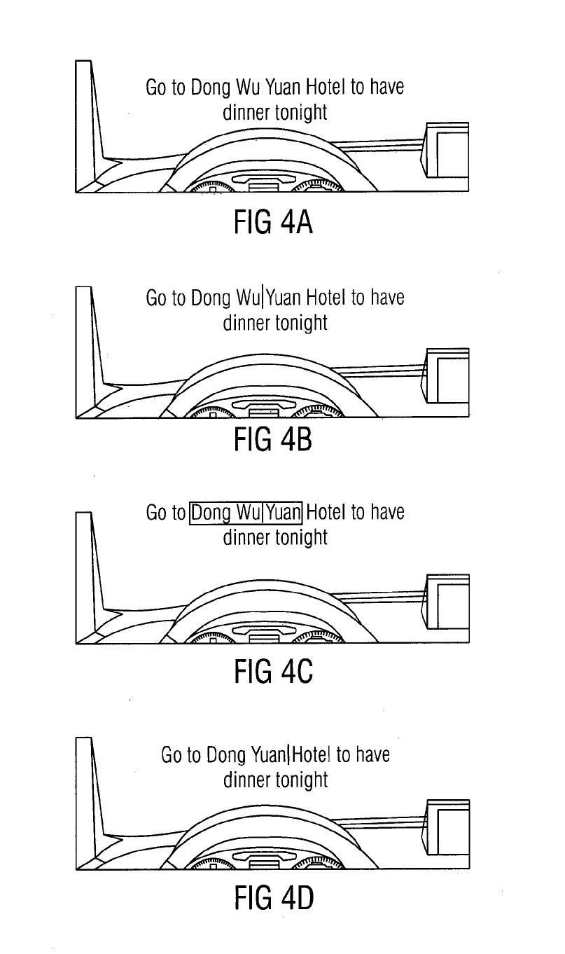

FIGS. 4A-4D show an example application scenario of a speech-to-text input system and method according to an embodiment of the present invention. The user is intended to edit a short message “go to Dong Yuan Hotel to have dinner tonight”, which is spoken out by the user in a manner of speech. The result fed back from the speech recognition system is “go to Dong Wu Yuan Hotel to have dinner tonight” (as shown in FIG. 4A). The user finds the recognition error, and gazes at three characters of “Dong Wu Yuan” so that the cursor moves to the scope of these three characters (as shown in FIG. 4B). The user says “select a word”, and the three characters of “Dong Wu Yuan” are selected (as shown in FIG. 4C). The user says “replace with Dong Yuan”. As a result, the three characters of “Dong Wu Yuan” are corrected as “Dong Yuan” (as shown in FIG. 4D).

The present invention can be implemented in the manner of hardware, software or a combination of hardware and software. The present invention can be implemented in a centralized manner in a computer system or be implemented in a distributed manner, and in such a distribution manner, different components are distributed in several interconnected computer systems. Any computer system or other device which is suitable to execute various methods as described here are suitable. A typical combination of hardware and software can be a general purpose computer system having a computer program, and when the computer program is loaded and executed, the computer system is controlled so as to enable same to execute the techniques described here.

The present invention can be also embodied in a computer program product, which program product contains all the features which are able to implement the methods described here, and when being loaded into the computer system, it can execute these methods.

Although the present invention has been illustrated and described specifically by referring to preferred embodiments, it should be understood by those skilled in the art that various changes in form and detail can be performed thereon without deviating from the spirit and scope of the present invention. The scope of the present invention is merely to be limited by the appended claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A speech-to-text input method on a system having a speech input receiver, a speech recognizer, a display, a gaze tracker and a text editor, the method comprising:
receiving, by the speech input receiver, a speech input from a user;
converting, by the speech recognizer, the input speech input into text, via speech recognition;
displaying, by the display, the recognized text to the user;
determining, by the gaze tracker, a gaze position of the user on the display by tracking the eye movement of the user;
displaying, by the display, an edit cursor at the gaze position when the gaze position is located at the displayed text;
receiving, by the speech input receiver, a speech edit command from the user;
recognizing, by the speech recognizer, the received speech edit command via speech recognition; and
editing, by the text editor, the text at the edit cursor according to the recognized speech edit command.

13. The method as claimed in claim 12, wherein the editing according to the speech edit command comprises one or more selected from the group of steps consisting of:
selecting a word before/a word after the edit cursor position;
replacing the word before/the word after the edit cursor position with a character, word, phrase or sentence of the speech input of the user;
deleting the word before/the word after the edit cursor position;
selecting a character before/a character after the edit cursor position;
replacing the character before/the character after the edit cursor position with the character, word, phrase or sentence of the speech input of the user;
deleting the character before/the character after the edit cursor position;
deleting all the contents after the edit cursor position; deleting all the contents before the edit cursor position; inserting the character, word, phrase or sentence of the speech input of the user at the edit cursor position; and
selecting the word located at the edit cursor position; replacing the selected word or character with the character, word, phrase or sentence of the speech input of the user; and deleting the selected word or character.

14. The method as claimed in claim 12, wherein the method is implemented in a vehicle, the display comprises a display screen implemented by a front windshield of the vehicle, applying head-up display technology.

15. The method as claimed in claim 12, wherein the speech recognition is executed by a remote speech recognition system that communicates in a wireless manner.

16. A speech-to-text input system, comprising:
a speech receiver configured to receive a speech input from a user;
a speech recognizer configured to convert the received speech input into via through speech recognition;
a display configured to display to the user the recognized text;
a gaze tracker configured to track eye movement of the user and determine a gaze position of the user on the displayed text by tracking the eye movement of the user;
the display being further configured to display an edit cursor at the gaze position when the gaze position is located at the displayed text;
the speech receiver further configured to receive a speech edit command from the user;
the speech recognizer further configured to recognize the speech edit command through speech recognition; and
a text editor configured to edit the text at the displayed edit cursor according to the recognized speech edit command.

17. The system as claimed in claim 16, wherein the editing of the edit module according to the recognized speech edit command comprises one or more selected from the group of actions consisting of:
selecting a word before/a word after the edit cursor position;
replacing the word before/the word after the edit cursor position with a character, word, phrase or sentence of the speech input of the user;
deleting the word before/the word after the edit cursor position;
selecting a character before/a character after the edit cursor position;
replacing the character before/the character after the edit cursor position with the character, word, phrase or sentence of the speech input of the user;
deleting the character before/the character after the edit cursor position;
deleting all the contents' after the edit cursor position;
deleting all the contents before the edit cursor position; inserting the character, word, phrase or sentence of the speech input of the user at the edit cursor position;
selecting the word located at the edit cursor position; and
replacing the selected word or character with the character, word, phrase or sentence of the speech input of the user; and deleting the selected word or character.

18. The system as claimed in claim 16, wherein the system is implemented in a vehicle, the display comprises a display screen implemented by a front windshield of the vehicle, and the display module applies a head-up display technology.

19. The system as claimed in claim 16, wherein the speech recognition module comprises a remote speech recognition system which communicates with the receiving module and the edit module in a wireless manner.

20. The system as claimed in claim 16, wherein the gaze tracking module comprises an eye tracker configured to track and measure a rotation angle of the eyeballs, and a gaze position determination device configured to determine the gaze position of the eyes according to the rotation angle of the eyeballs measured by the eye tracker.

21. The system as claimed in claim 16, wherein the receiving module comprises a microphone configured to receive the speech input from the user.

22. The system as claimed in claim 16, further comprising a controller which is configured to control the operation of the receiving module, speech recognition module, display module and gaze tracking module, wherein the controller is implemented by a computing device which comprises a processor and a storage.
